(19) United States
(12) Patent Application Publication
(10) Pub. No.: US 2022/0290888 A1
(43) Pub. Date: Sep. 15, 2022

(54) INFORMATION PROCESSING DEVICE, INFORMATION PROCESSING SYSTEM, AND CONTROL METHOD

(71) Applicant: SHARP KABUSHIKI KAISHA, Sakai City, Osaka (JP)

(72) Inventor: TAIKI MAEZONO, Sakai City, Osaka (JP)

(21) Appl. No.: 17/636,222

(22) PCT Filed: Aug. 25, 2020
(86) PCT No.: PCT/JP2020/031908

§ 371 Date: Feb. 17, 2022

(30) Foreign Application Priority Data
Aug. 28, 2019 (JP) 2019-155900

(51) Int. Cl. F24F 11/49; F24F 6/00; F24F 11/64

(52) U.S. Cl. CPC F24F 11/49; F24F 6/00; F24F 11/64

(57) ABSTRACT

An information processing device includes: an acquisition unit configured to acquire installation information including information regarding an installation environment of a home electric appliance; and a transmission unit configured to transmit first start information to the home electric appliance, the first start information being information for causing the home electric appliance to start a verification operation of verifying an output amount corresponding to the installation environment, after the home electric appliance is installed. The transmission unit causes the home electric appliance to start the verification operation with a verification amount obtained from the installation information and home electric appliance information, on the basis of information in which a relationship between the installation environment and the verification amount indicating an output amount during the verification operation is indicated for each piece of home electric appliance information including information by which the home electric appliance is able to be identified.

### TECHNICAL FIELD

The present disclosure relates to an information processing device and the like. The present application claims priority from JP 2019-155900 filed in Japan on Aug. 28, 2019, the content of which is hereby incorporated by reference into this application.

### BACKGROUND ART

PTL 1 described below discloses a technique capable of reducing the power consumption of a blower or a hot air heater with the blowing noise of the blower not becoming a concern even when a humidifier is used in a room different from one having the applicable number of tatami mats for the humidifier.

### CITATION LIST

### Patent Literature

PTL 1: JP 2006-132879 A

### SUMMARY OF INVENTION

### Technical Problem

In the humidifier disclosed in PTL 1, it is determined that a room in which the humidifier is used is larger than one with the applicable number of tatami mats in a case where a measured time from the start of operation until a detected humidity approaches a target humidity and enters a stable region is higher than a predetermined value, and a number of control stages having a large humidification amount is used from among a plurality of control stages.

An object of an aspect of the present disclosure is to realize an information processing device and the like capable of controlling an air-conditioning unit so as to efficiently improve the environment of a room.

### Solution to Problem

An information processing device according to an aspect of the present disclosure includes an acquisition unit configured to acquire installation information including information regarding an installation environment of a home electric appliance, and a transmission unit configured to transmit first start information to the home electric appliance, the first start information being information for causing the home electric appliance to start a verification operation of verifying an output amount corresponding to the installation environment, after the home electric appliance is installed, and the transmission unit causes the home electric appliance to start the verification operation with a verification amount obtained from the installation information and home electric appliance information, on the basis of information in which a relationship between the installation environment and the verification amount indicating an output amount during the verification operation is indicated for each piece of home electric appliance information including information by which the home electric appliance is able to be identified.

A method of controlling an information processing device according to an aspect of the present disclosure includes an acquisition step of acquiring installation information including information regarding an installation environment of a home electric appliance, and a transmission step of transmitting first start information to the home electric appliance, the first start information being information for causing the home electric appliance to start a verification operation of verifying an output amount corresponding to the installation environment, after the home electric appliance is installed, and in the transmission step, the home electric appliance is caused to start the verification operation with a verification amount obtained from the installation information and home electric appliance information, on the basis of information in which a relationship between the installation environment and the verification amount indicating an output amount during the verification operation is indicated for each piece of home electric appliance information including information by which the home electric appliance is able to be identified.

A control program of an information processing device according to an aspect of the present disclosure is configured to cause an information processing device to realize an acquisition function of acquiring installation information including information regarding an installation environment of a home electric appliance, and a transmission function of transmitting first start information to the home electric appliance, the first start information being information for causing the home electric appliance to start a verification operation of verifying an output amount corresponding to the installation environment, after the home electric appliance is installed, and the transmission function causes the home electric appliance to start the verification operation with a verification amount obtained from the installation information and home electric appliance information, on the basis of information in which a relationship between the installation environment and the verification amount indicating an output amount during the verification operation is indicated for each piece of home electric appliance information including information by which the home electric appliance is able to be identified.

### BRIEF DESCRIPTION OF DRAWINGS

FIG. 1 is a system configuration diagram illustrating a configuration of a control system and an information processing system according to a first embodiment.

FIG. 2 is a block diagram illustrating an example of main components of a server according to the first embodiment.

FIG. 3 is a block diagram illustrating an example of main components of an air-conditioning unit according to the first embodiment,

FIG. 4 is an example of data of installation information acquired by the server.

FIG. 5A is an example of information indicating a relationship between the size of an installation environment, the structure thereof, and the degree of appropriateness of the size thereof.

FIG. 5B is an example of information indicating a relationship between the size of an installation environment, the structure thereof, and the degree of appropriateness of the size thereof.

FIG. 5C is an example of information indicating a relationship between the size of an installation environment, the structure thereof, and the degree of appropriateness of the size thereof.

FIG. 6A is an example of information indicating a relationship between the degree of appropriateness for an installation environment and a humidification amount for each degree of appropriateness.

FIG. 6B is an example of information indicating a relationship between the degree of appropriateness for an installation environment and the humidification amount for each degree of appropriateness.

FIG. 6C is an example of information indicating a relationship between the degree of appropriateness for an installation environment and the humidification amount for each degree of appropriateness.

FIG. 7A is an example of a graph illustrating changes in humidity in an installation environment.

FIG. 7B is an example of a graph illustrating changes in humidity in an installation environment.

FIG. 7C is an example of a graph illustrating changes in humidity in an installation environment.

FIG. 8A is an example of information indicating the humidification amount based on the degree of appropriateness for an installation environment and humidification performance in the installation environment.

FIG. 8B is an example of information indicating the humidification amount based on the degree of appropriateness for an installation environment and humidification performance in the installation environment.

FIG. 8C is an example of information indicating the humidification amount based on the degree of appropriateness for an installation environment and humidification performance in the installation environment.

FIG. 9 is an example of first start information, second start information, and third start information that are transmitted to an air-conditioning unit by the server.

FIG. 10A is an example of a screen displayed on a user terminal according to the first embodiment.

FIG. 10B is an example of a screen displayed on the user terminal,

FIG. 11 is a timing chart illustrating an example of processing executed in the information processing system.

FIG. 12 is a flowchart illustrating an example of verification amount determination processing executed by the server.

FIG. 13 is a flowchart illustrating an example of output amount determination processing executed by the server.

FIG. 14 is a flowchart illustrating an example of output amount re-determination processing executed by the server.

### DESCRIPTION OF EMBODIMENTS

### First Embodiment

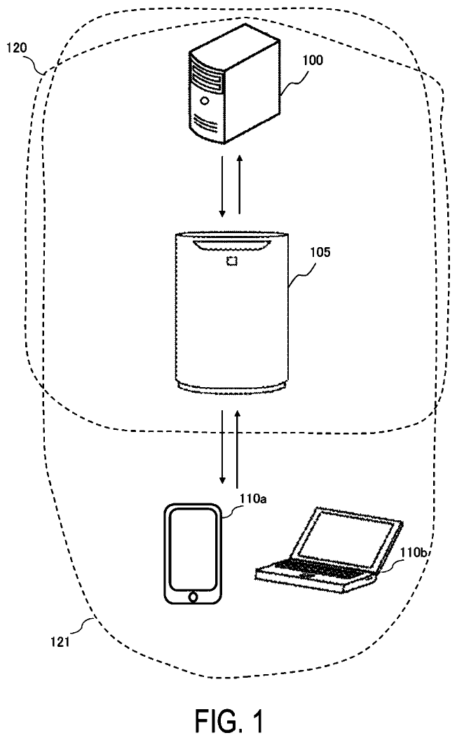

A first embodiment (Embodiment 1) will be described based on FIGS. 1 to 14. Note that, in the drawings, the same or equivalent components are denoted by the same reference numerals and signs, and repeated description thereof will be omitted.

### Outline of Server 100

FIG. 1 is a system configuration diagram illustrating an example of a configuration of a control system (information processing system) 120 and an example of a configuration of an information processing system 121.

As illustrated in FIG. 1, the control system 120 may be a system including, for example, a server (information processing device) 100 and an air-conditioning unit (home electric appliance) 105. The information processing system 121 may be, for example, a system in which a smartphone (user terminal) 110a is added to the control system 120. Note that, as illustrated in FIG. 1, the information processing system 121 may further include a notebook PC (user terminal) 110b. That is, the number of user terminals included in the information processing system 121 may be one or more.

The air-conditioning unit 105 is a home electric appliance having a humidity adjustment function of adjusting humidity such as humidification and dehumidification. In the present embodiment, an air-conditioning unit 105 is described as an example of a home electric appliance, but the type is not limited as long as the home electric appliance is equipment having the above-described humidity adjustment function (for example, a home electric appliance may be a humidifier, an air cleaner, an air conditioner, or the like).

The air-conditioning unit needs to continue a humidification operation until the humidity of an installation environment (hereinafter, referred to as a “room humidity”) reaches a target humidity. At this time, in a case where the size of the installation environment (for example, a floor area) and an appropriate size for the performance of the air-conditioning unit deviate from each other, there is a concern that the efficiency of humidification may be degraded.

Consequently, the server 100 acquires installation information including information related to the installation environment of the air-conditioning unit 105, and, after the air-conditioning unit 105 is installed, transmits first start information for causing the air-conditioning unit 105 to start a verification operation of verifying an output amount corresponding to the installation environment to the air-conditioning unit 105. In addition, the server 100 causes the air-conditioning unit 105 to start a verification operation with a verification amount obtained from the installation information and home electric appliance information, on the basis of information in which a relationship between the installation environment and the verification amount indicating an output amount during the verification operation is indicated for each piece of home electric appliance information including information by which the air-conditioning unit 105 can be identified.

Thereby, the server 100 can start the verification operation with, for example, an appropriate humidification amount corresponding to an installation environment and the performance of the air-conditioning unit 105. That is, the server 100 has an effect that an optimum output amount can be attempted until a room humidity reaches a target humidity.

Note that the server 100 may further transmit second start information for causing the air-conditioning unit 105 to start a normal operation with an output amount determined on the basis of a change value indicating changes in an installation environment due to a verification operation to the air-conditioning unit 105.

Thereby, the server 100 can perform a normal operation with an optimum humidification amount in accordance with changes in a room humidity and the like after performing the verification operation. Thus, the server 100 has an effect that, for example, it is possible to reduce a time until the room humidity reaches a target humidity, reduce the frequency of feeding water, and reduce power consumption.

### Configuration of Server 100

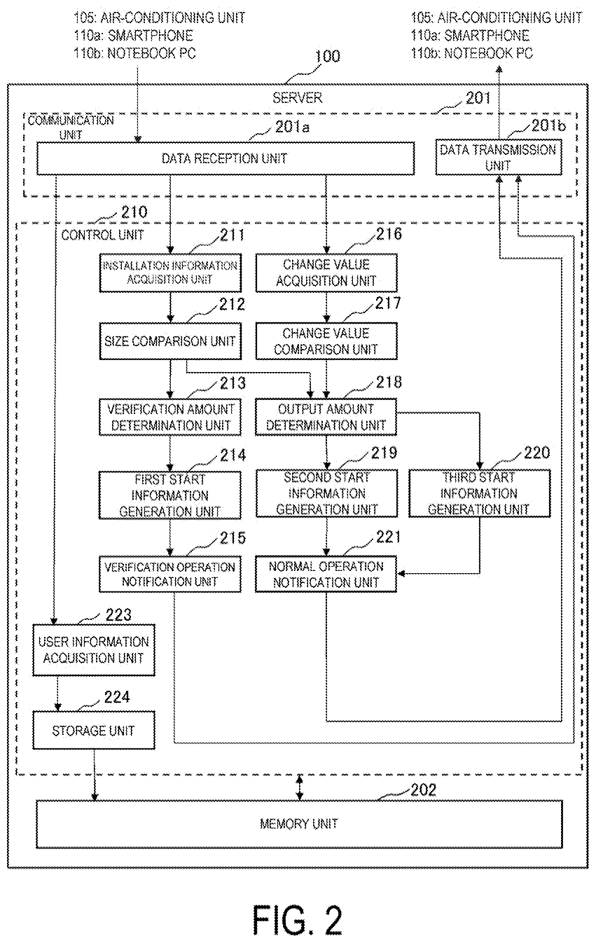

FIG. 2 is a block diagram illustrating an example of main components of the server. As illustrated in FIG. 2, the server (information processing device) 100 may include, for example, a communication unit 201, a memory unit 202, and a control unit 210. The control unit 210 may include an installation information acquisition unit 211, a size comparison unit 212, a verification amount determination unit 213, a first start information generation unit 214, a verification operation notification unit 215, a change value acquisition unit 216, a change value comparison unit 217, an output amount determination unit 218, a second start information generation unit 219, a third start information generation unit 220, a normal operation notification unit 221, a user information acquisition unit 223, and a storage unit 224.

The control unit 210 has a function of integrally controlling various types of functions of the server 100, and is realized by a controller (a processor) such as a central processing unit (CPU).

The communication unit 201 transmits and receives various data with respect to the air-conditioning unit 105 and a user terminal (for example, a smartphone 110a and a notebook PC 110b) via a network. Note that the communication unit 201 may be hardware capable of communicating with the outside via a network, for example, according to a predetermined communication method. It is sufficient that the communication unit 201 be provided with an essential function for realizing communication with external equipment, and a communication channel, a communication method, a communication medium, and the like are not limited. The communication unit 201 includes a data reception unit 201a and a data transmission unit 201b.

For example, the data reception unit 201a may receive various pieces of information from the smartphone 110a (or the notebook PC 110b), and output the information to each of the units included in the control unit 210.

For example, the data transmission unit 201b may transmit various pieces of information input from each of the units included in the control unit 210 to the air-conditioning unit 105 or the smartphone 110a (or the notebook PC 110b).

The installation information acquisition unit (acquisition unit) 211 acquires installation information including information regarding the installation environment of the air-conditioning unit 105 (hereinafter, simply referred to as “installation information”) (from, for example, the air-conditioning unit 105, the smartphone 110a, or the like). Here, the installation information may be information including, for example, the size of a room in which the air-conditioning unit 105 is installed (for example, the number of tatami mats, the number of square meters, or the like) and the structure of the room (for example, a wooden Japanese-style room, a prefabricated Western-style room, or the like).

In addition, the installation information acquisition unit 211 may acquire, for example, installation information and home electric appliance information including information by which the air-conditioning unit 105 can be identified (for example, a model name, a serial number, a manufacturing number, and the like), which are associated with each other, from the smartphone 110a.

Further, the installation information acquisition unit 211 may acquire, for example, updated installation information in a case where the installation information is updated. Here, the installation information acquisition unit 211 acquires installation information of an installation environment when the air-conditioning unit 105 purchased by a user is installed for the first time, as updated installation information. In addition, the installation information acquisition unit 211 may acquire installation information of another installation environment when the installation environment of the air-conditioning unit 105 already installed by the user is changed to another installation environment, as updated installation information,

Further, in a case where the installation information acquisition unit 211 has acquired, for example, a registration request for registering the air-conditioning unit 105 in the server 100, the installation information acquisition unit 211 may acquire updated installation information.

The size comparison unit 212 compares, for example, the size of the installation environment included in the installation information (for example, a floor area such as the number of tatami mats, the number of square meters, or the like) with a size specified for each piece of home electric appliance information (that is, a size which is appropriate for the performance of the air-conditioning unit 105 and is read from, for example, the memory unit 202).

The verification amount determination unit (transmission unit) 213 determines a verification amount obtained from installation information and home electric appliance information on the basis of information in which a relationship between an installation environment and the verification amount indicating an output amount during a verification operation is indicated for each piece of home electric appliance information including information by which the air-conditioning unit 105 can be identified. In addition, the verification amount determination unit 213 determines, for example, a humidification amount corresponding to a result of the comparison between the size of the installation environment included in the installation information and a size specified for each air-conditioning unit 105 as a verification amount.

The first start information generation unit 214 generates, for example, first start information for causing the air-conditioning unit 105 to start a verification operation of verifying an output amount corresponding to an installation environment. Here, for example, the first start information may include the above-described verification amount and operation information for operating the air-conditioning unit 105. Note that the operation information may be information including, for example, the type of operation such as a humidification operation and an instruction for starting the operation. The air-conditioning unit 105 starts an operation corresponding to the type of operation on the basis of the operation information.

The verification operation notification unit (transmission unit) 215 transmits, to the air-conditioning unit 105, first start information for causing a home electric appliance to start a verification operation of verifying an output amount corresponding to an installation environment, after the air-conditioning unit 105 is installed. In addition, the verification operation notification unit 215 causes the air-conditioning unit 105 to start a verification operation with a verification amount obtained from the installation information and the home electric appliance information, on the basis of the information in which a relationship between the installation environment and the verification amount indicating an output amount during the verification operation is indicated for each piece of home electric appliance information including information by which the air-conditioning unit 105 can be identified.

In addition, for example, when a humidification amount is obtained using installation information and home electric appliance information, the verification operation notification unit 215 causes the air-conditioning unit 105 to start a humidification operation as a verification operation using the humidification amount as a verification amount. In addition, for example, the verification operation notification unit 215 causes the air-conditioning unit 105 to start a verification operation using, as a verification amount, a humidification amount corresponding to a result of the comparison between the size of the installation environment included in the installation information and a size specified for each piece of home electric appliance information.

Further, for example, in a case where updated installation information is acquired, the verification operation notification unit 215 may transmit the first start information for causing the air-conditioning unit 105 to start a verification operation to the air-conditioning unit 105.

Further, for example, the verification operation notification unit 215 further transmits condition information for presenting conditions for setting an installation environment to the air-conditioning unit 105 to a user of the air-conditioning unit 105. Here, the condition information is, for example, information of conditions of the installation environment necessary to perform a verification operation, and may be message information for notifying a user of the conditions such as “Close the door” or “Close the window”.

The change value acquisition unit 216 may acquire a change value indicating a change in the installation environment due to the verification operation from the air-conditioning unit 105. Here, the change value may be a value indicating a change in humidity in the installation environment in which the air-conditioning unit 105 is installed, or may be a value indicating a change in a measured value based on the humidity and the temperature.

Further, the change value acquisition unit 216 may acquire a change value indicating a change in the installation environment due to a normal operation from the air-conditioning unit 105 after a predetermined period of time has elapsed since the normal operation started. Further, for example, the change value acquisition unit 216 may acquire a change value of the humidity in the installation environment after the air-conditioning unit 105 performs a humidification operation as a verification operation or a normal operation.

Note that the change value acquisition unit 216 may acquire, (for example, measured values for example, a humidity, a temperature, and the like) of the installation environment, which are measured before and after the verification operation and the normal operation are started, from the air-conditioning unit 105, may calculate a difference between the acquired two measured values, and may acquire a value indicated by the difference as a change value of the installation environment due to the verification operation and the normal operation. In addition, the change value acquisition unit 216 may acquire measured values measured for each predetermined period of time (for example, every 30 minutes) not only before and after the start of the verification operation and the normal operation, and may acquire a difference value between a measured value measured at a certain timing and a measured value measured at another timing as a change value.

The change value comparison unit 217 may compare, for example, the above-described change value with a reference value corresponding to home electric appliance information of the air-conditioning unit 105. Here, the reference value is a value indicating the performance of each of the home electric appliances (details will be described later). In addition, the change value comparison unit 217 may output, for example, a comparison result indicating whether the change value is a small value falling outside a predetermined range from the reference value, is a value falling within the predetermined range, or is a large value falling outside the predetermined range to the output amount determination unit 218.

For example, the output amount determination unit (determination unit) 218 determines an output amount on the basis of a change value indicating a change in the installation environment due to the verification operation. For example, the output amount determination unit 218 determines a humidification amount as an output amount on the basis of a change value of the humidity in the installation environment after the air-conditioning unit 105 performs a humidification operation as a verification operation or a normal operation.

In addition, the output amount determination unit 218 determines an output amount smaller than the determined output amount in a case where a change value indicating a change in the installation environment due to the normal operation is smaller than a predetermined value after a predetermined period of time has elapsed since the normal operation started.

In addition, for example, the output amount determination unit 218 determines a humidification amount as an output amount on the basis of a change value of the humidity of the installation environment after the air-conditioning unit 105 performs a humidification operation as a verification operation or a normal operation. Further, for example, the output amount determination unit 218 determines an output amount further on the basis of user information including information regarding a user of the air-conditioning unit 105. In addition, for example, the output amount determination unit 218 evaluates the propriety of the verification amount in accordance with a change value indicating a change in the installation environment, and determines an output amount from the evaluation result and installation information.

For example, the second start information generation unit 219 generates second start information for causing the air-conditioning unit 105 to start a normal operation with the output amount determined by the output amount determination unit 218. Here, for example, the second start information may further include information related to the type of operation (for example, a humidification operation) when operating the air-conditioning unit 105.

For example, the third start information generation unit 220 generates third start information including at least an output amount smaller than an output amount determined by the output amount determination unit 218 and the type of operation of operating the air-conditioning unit 105 (for example, a humidification operation).

For example, the normal operation notification unit (transmission unit) 221 further transmits second start information for causing the air-conditioning unit 105 to start a normal operation with the output amount determined by the output amount determination unit 218. In addition, for example, the verification operation notification unit 215 further transmits third start information for continuing a normal operation with an output amount smaller than the output amount determined by the output amount determination unit 218.

For example, the user information acquisition unit (acquisition unit) 223 acquires installation information input by the user of the air-conditioning unit 105 from a user terminal via a predetermined interface presented to the user terminal, and outputs the acquired installation information to the storage unit 224.

For example, the storage unit 224 stores user information including information regarding the user of the air-conditioning unit 105 in the memory unit 202 in association with home electric appliance information.

The memory unit 202 is storage equipment capable of storing any information, and may be constituted by, for example, a hard disk, a silicon state drive (SSD), a semiconductor memory, a DVD, or the like.

### Configuration of Air-Conditioning Unit 105

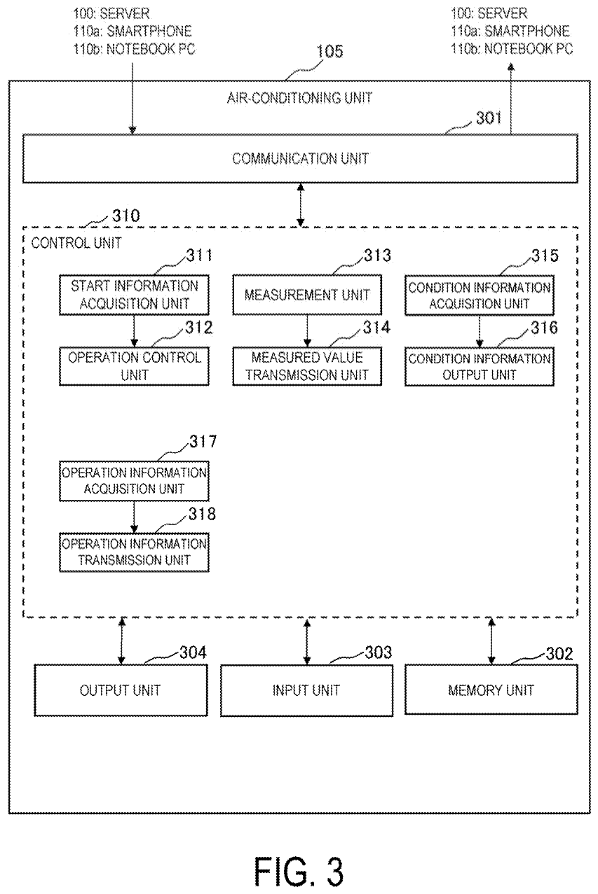

FIG. 3 is a block diagram illustrating an example of main components of main portions of the air-conditioning unit 105. As illustrated in FIG. 3, the air-conditioning unit (home electric appliance) 105 may include, for example, a communication unit 301, a memory unit 302, an input unit 303, an output unit 304, and a control unit 310. In addition, the control unit 310 may include a start information acquisition unit 311, an operation control unit 312, a measurement unit 313, a measured value transmission unit 314, a condition information acquisition unit 315, a condition information output unit 316, an operation information acquisition unit 317, and an operation information transmission unit 318.

The control unit 310 has a function of integrally controlling various types of functions of the air-conditioning unit 105, and is realized by a controller (processor) such as a central processing unit (CPU).

The communication unit 301 receives, for example, various data from the server 100. In addition, the communication unit 301 transmits a measured value obtained by measuring a room humidity, a temperature, and the like, and operation information indicating operation details of an operation performed by the air-conditioning unit 105, and the like to the server 100.

The input unit 303 receives, for example, contents of an operation performed by a user through keys installed on an outer surface of the air-conditioning unit 105, a display device with a touch panel, a remote controller, or the like.

The output unit 304 includes, for example, a humidification unit that performs humidification, an air cleaning unit that performs air cleaning, a blowing unit that blows air, a sound output unit that outputs sound, a display unit that performs display, and the like, which are controlled by the control unit 310.

The start information acquisition unit (start information reception unit) 311 receives, for example, the first start information for starting a verification operation of verifying an output amount corresponding to the installation environment from the server 100. In addition, the start information acquisition unit 311 may further receive, for example, the second start information and the third start information from the server 100.

The operation control unit 312 starts an operation of the output unit 304 (for example, a humidification unit) so as to start a verification operation with a verification amount included in the first start information on the basis of, for example, the first start information, Similarly, the operation control unit 312 starts and continues an operation of the output unit 304 on the basis of, for example, the second start information and the third start information.

The measurement unit 313 measures a physical quantity (for example, a humidity, a temperature, the amount of water vapor, and the like) of the installation environment, and outputs the measured value to the measured value transmission unit 314.

The measured value transmission unit 314 transmits the above-described measured value to the server 100 via the communication unit 301.

For example, the condition information acquisition unit (condition information reception unit) 315 acquires condition information for causing the air-conditioning unit 105 to present conditions for setting an installation environment to the user of the air-conditioning unit 105.

For example, the condition information output unit 316 outputs the condition information acquired by the condition information acquisition unit 315 from the output unit 304. Specifically, the condition information output unit 316 outputs the sound of message information for notifying the user of the conditions, such as “Close the door” or “Close the window” from the sound output unit.

The operation information acquisition unit 317 acquires, for example, operation information indicating operation details of an operation performed on a humidity, a temperature, and the like by the user. In addition, the operation information acquisition unit 317 may acquire, for example, the operation information and an operation time indicating the time of the operation in association with each other.

The operation information transmission unit 318 transmits, for example, the operation information to the server 100 via the communication unit 301. In addition, the operation information transmission unit 318 may transmit, for example, the operation information and the operation time in association with each other to the server 100 via the communication unit 301.

The memory unit 302 is storage equipment capable of storing any information, and may be constituted by, for example, a hard disk, a silicon state drive (SSD), a semiconductor memory, or the like.

### Processing for Server 100 to Acquire Installation Information

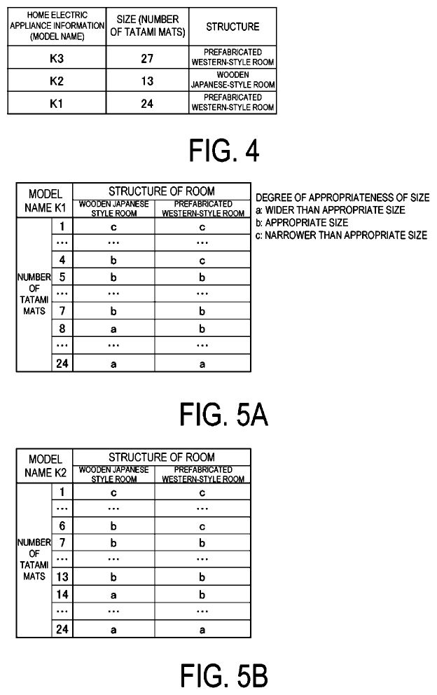

FIG. 4 is an example of data of installation information acquired by the server 100. As illustrated in FIG. 4, the installation information acquisition unit 211 acquires, for example, data of the size and structure of an installation environment in which the air-conditioning unit 105 is installed from the smartphone 110a (or the notebook PC 210a) in association with home electric appliance information by which the air-conditioning unit 105 can be identified.

Specifically, as illustrated in FIG. 4, the installation information acquisition unit 211 acquires a size “27 tatami mats” of a room in which the air-conditioning unit 105 is installed and a structure “prefabricated Western-style room” of the room as data in association with home electric appliance information “K3” (for example, the model name, the manufacturing number, and the like of the air-conditioning unit 105). Similarly, the installation information acquisition unit 211 acquires a size “13 tatami mats” and a structure “wooden Japanese-style room” corresponding to home electric appliance information “K2” and acquires a size “24 tatami mats” and a structure “prefabricated Western-style room” corresponding to home electric appliance information “K1”.

Thereby, the server 100 can identify the size and structure of a room, which is information regarding the installation environment in which the home electric appliance is installed, for each piece of home electric appliance information by which the home electric appliance can be identified.

Information of Installation Environment Associated with Air-Conditioning Unit 105

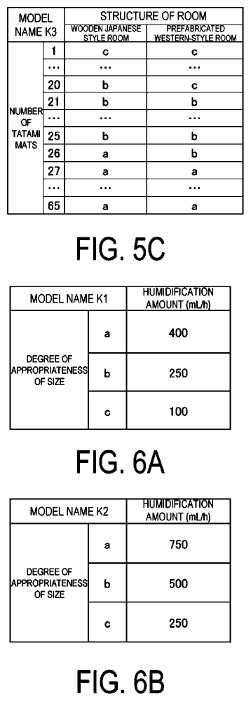

FIGS. 5A to 5C are examples of information indicating a relationship between the size of an installation environment (the number of tatami mats), the structure thereof, and the degree of appropriateness of the size thereof, FIG. 5A is an example of the information for a model name “K1”, FIG. 5B is an example of the information for a model name “K2”, and FIG. 5C is an example of the information for a model name “K3”. Note that the information is stored in, for example, the memory unit 202 included in the server 100.

As illustrated in FIG. 5A, in the air-conditioning unit 105 having a model name “K1”, each number of tatami mats of from “four tatami mats” to “seven tatami mats” has a degree of appropriateness “b” in a case where the structure of the room is a “wooden Japanese-style room” (which is not limited to a wooden room and may be a room where moisture can easily escape), which is stored in the memory unit 202 by the server 100. Here, the degree of appropriateness “b” indicates that the size of the installation environment is a size appropriate for the performance of the air-conditioning unit 105.

As illustrated in FIG. 5B, in the air-conditioning unit 105 having a model name“K2”, each number of tatami mats of from “one tatami mat” to “six tatami mats” has a degree of appropriateness “c” in a case where the structure of the room is a “prefabricated Western-style room” (a room with high airtightness), which is stored in the memory unit 202 by the server 100. Here, the degree of appropriateness “c” indicates that the size of the installation environment is narrow for the performance of the air-conditioning unit 105.

As illustrated in FIG. 5C, in the air-conditioning unit 105 having a model name “K3”, each number of tatami mats of from “27 tatami mats” to “65 tatami mats” has a degree of appropriateness “a” in a case where the structure of the room is a “wooden Japanese-style room”, which is stored in the memory unit 202 by the server 100. Here, the degree of appropriateness “a” indicates that the size of the installation environment is wide for the performance of the air-conditioning unit 105.

Note that the server 100 may store the number of tatami mats and a structure corresponding to the degree of appropriateness “b” indicating being an appropriate number of tatami mats in the memory unit 202, the numbers of tatami mats and structures corresponding to the degree of appropriateness “a” and the degree of appropriateness “c” do not necessarily need to be stored. In addition, the server 100 may have four or more degrees of appropriateness, rather than three degrees of appropriateness. Further, the server 100 may store the degrees of appropriateness for the respective numbers of tatami mats which are represented by numerical values of 0 to 100.

Thereby, the server 100 can easily determine whether the size of the installation environment is a size appropriate for the performance of the air-conditioning unit 105.

Relationship Between Degree of Appropriateness Associated with Air-Conditioning Unit 105 and Humidification Amount

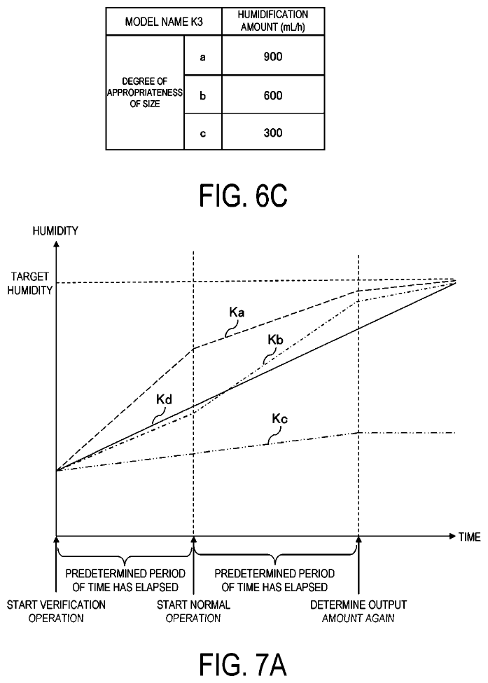

FIGS. 6A to 6C are examples of information indicating a relationship between the degree of appropriateness for an installation environment (for example, a size) and a humidification amount for each degree of appropriateness, FIG. 6A is an example of the information for a model name “K1”, FIG. 6B is an example of the information for a model name “K2”, and FIG. 6C is an example of the information for a model name “K3”.

As illustrated in FIG. 6A, for the air-conditioning unit 105 having a model name “K1”, a humidification amount “400” is associated with the degree of appropriateness “a” (wide), a humidification amount “250” is associated with the degree of appropriateness “b” (appropriate), and a humidification amount “100” is associated with the degree of appropriateness “c” (narrow), and the associations are stored in the memory unit 202 by the server 100.

Similarly, as illustrated in FIGS. 6B and 6C, for the air-conditioning units 105 having model names “K2” and “K3”, each degree of appropriateness and a humidification amount for the degree of appropriateness are associated, and the associations are stored in the memory unit 202 by the server 100.

Thereby, the server 100 can determine a humidification amount corresponding to the degree of appropriateness. Thus, for example, the server 100 can start a verification operation with an appropriate humidification amount corresponding to the installation environment and the performance of the air-conditioning unit 105.

Here, the server 100 may store only a humidification amount corresponding to a predetermined degree of appropriateness without storing a humidification amount in association with each degree of appropriateness, and may calculate humidification amounts for other degrees of appropriateness by multiplying the humidification amount corresponding to the predetermined degree of appropriateness by a constant according to the model of the air-conditioning unit.

For example, the transmission unit causes the home electric appliance to start the verification operation with the verification amount obtained by multiplying a predetermined amount corresponding to installation information by a constant according to the home electric appliance information. Thereby, the server 100 can determine a humidification amount flexibly corresponding to the type of home electric appliance. Thus, for example, the server 100 can start the verification operation with an appropriate humidification amount corresponding to the installation environment and the performance of the air-conditioning unit 105.

In addition, the server 100 may store information indicating a relationship between the degree of appropriateness and a verification amount in accordance with a region where the server 100 is installed. For example, the transmission unit causes the home electric appliance to start the verification operation with the verification amount obtained from the installation information, the home electric appliance information, and region information included in the installation information. Thereby, the server 100 can acquire a region where the air-conditioning unit 105 is installed, and determine an appropriate verification amount corresponding to the installation region.

### Processing for Server 100 to Determine Verification Amount of Verification Operation

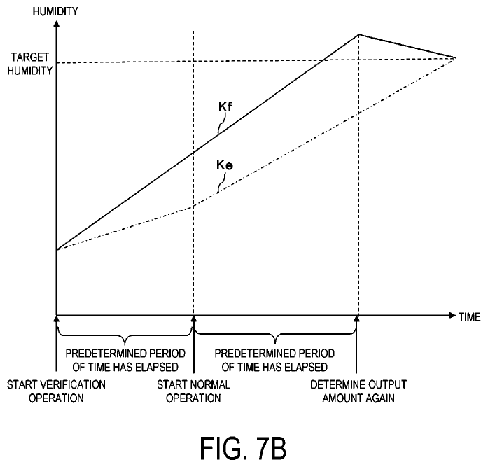

FIGS. 7A to 7C are examples of graphs illustrating changes in humidity in an installation environment in which the air-conditioning unit 105 is installed. Graphs Ka to Kc, Ke, and Kg are graphs showing changes in humidity in an installation environment when the air-conditioning unit 105 operates in response to an instruction given from the server 100, and graphs Kd, Kf, and Kh are graphs showing changes in humidity in an installation environment when a conventional air-conditioning unit operates.

In a case where the installation information acquisition unit 211 acquires a model name “K3” as the home electric appliance information of the air-conditioning unit 105 and acquires the number of tatami mats “27” and a structure “prefabricated Western-style room” as installation information indicating the installation environment (see FIG. 4), the server 100 determines a verification amount by the following processing.

First, the size comparison unit 212 retrieves the number of tatami mats “27” and the structure “prefabricated Western-style room” from sizes and structures specified for the air-conditioning unit 105 having a model name “K3”, and acquires the degree of appropriateness “a” indicating that the number of tatami mats “27” and the structure “prefabricated Western-style room” are a large number of tatami mats for the performance of the air-conditioning unit 105 (see FIG. 5C),

In addition, the verification amount determination unit 213 determines a humidification amount “900” corresponding to the degree of appropriateness “a” from data of humidification amounts corresponding to the model name “K3” as a verification amount of a verification operation (see FIG. 6C).

Next, the first start information generation unit 214 generates first start information including a verification amount of the humidification amount “900” and operation information of a humidification operation of humidifying with and operating the air-conditioning unit 105. In addition, the verification operation notification unit 215 transmits the first start information including the humidification amount “900” and the operation information of the humidification operation to the air-conditioning unit 105 via the data transmission unit 201b, and causes the air-conditioning unit 105 to start a verification operation of a humidification operation with the humidification amount “900”.

The graph Ka in FIG. 7A is a graph illustrating changes in humidity in the installation environment when the air-conditioning unit 105 has performed a verification operation with a large humidification amount of the humidification amount “900”. The server 100 causes the air-conditioning unit 105 to start the verification operation with a humidification amount (for example, 900) which is larger than a predetermined humidification amount (for example, 600) when an operation is started by a conventional air-conditioning unit.

FIG. 7A shows that the graph Ka is approaching a target humidity more rapidly than the graph Kd. That is, the server 100 can bring a room humidity close to a target humidity more rapidly than a conventional air-conditioning unit.

Similarly, in a case where the installation information acquisition unit 211 acquires a model name “K3” as home electric appliance information of the air-conditioning unit 105 and acquires the number of tatami mats “10” and a structure “prefabricated Western-style room” as installation information indicating an installation environment (see FIG. 4), the server 100 determines a verification amount by the following processing.

First, the size comparison unit 212 retrieves the number of tatami mats “10” and the structure “prefabricated Western-style room” from sizes and structures specified for the air-conditioning unit 105 having a model name “K3”, and acquires the degree of appropriateness “c” indicating that the number of tatami mats “10” and the structure “prefabricated Western-style room” are a small number of tatami mats for the performance of the air-conditioning unit 105 (see FIG. 5C).

In addition, the verification amount determination unit 213 determines a humidification amount “300” corresponding to the degree of appropriateness “c” from data of humidification amounts corresponding to the model name “K3” as a verification amount of a verification operation (see FIG. 6C), and the server 100 causes the air-conditioning unit 105 to start a verification operation with a humidification amount “300”.

The graph Ke in FIG. 7B is a graph illustrating changes in a room humidity when the air-conditioning unit 105 has performed a verification operation in an installation environment having a small number of tatami mats for the performance of the air-conditioning unit 105. The server 100 causes the air-conditioning unit 105 to start the verification operation with a humidification amount (for example, 300) which is smaller than a predetermined humidification amount (for example, 600) when an operation is started by a conventional air-conditioning unit. FIG. 7B shows that the graph Ke does not exceed a target humidity as in the graph Kf and is approaching the target humidity.

That is, in a case where the size of the installation environment in which the air-conditioning unit 105 is installed is narrower than a size appropriate for the performance of the air-conditioning unit 105, the server 100 causes the air-conditioning unit 105 to start a verification operation with a small humidification amount. Thereby, the server 100 can reduce excessive humidification and reduce the frequency of feeding water to the air-conditioning unit 105. In addition, the server 100 can suppress an operation sound accompanying excessive humidification and does not discomfort a user.

### Processing for Server 100 to Determine Output Amount of Normal Operation

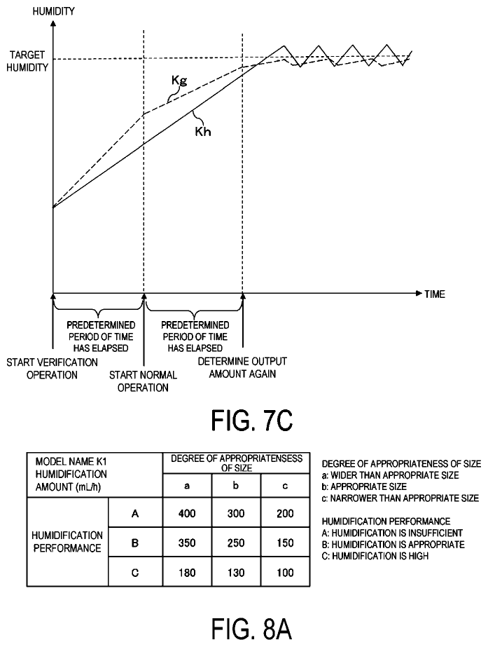

FIGS. 8A to 8C are examples of information indicating a humidification amount corresponding to the degree of appropriateness of the size of an installation environment and humidification performance in the installation environment. FIG. 8A is an example of the information for a model name “K1”, FIG. 8B is an example of the information for a model name “K2”, and FIG. 8C is an example of the information for a model name “K3”.

First, after the server 100 causes the air-conditioning unit 105 to perform a verification operation, the change value acquisition unit 216 acquires a change value of a room humidity in a period from the start of the verification operation until after a predetermined period of time has elapsed (for example, 1 hour after) from the air-conditioning unit 105 via the data reception unit 210a.

In addition, the change value comparison unit 217 compares the acquired change value of the humidity with a reference value specified for each piece of home electric appliance information. Here, the reference value is, for example, a value indicating a change in humidity in each installation environment when each home electric appliance corresponding to each piece of home electric appliance information has performed a humidification operation in the installation environment having a predetermined size and a predetermined structure, and is a value specified in association with each home electric appliance. That is, the reference value is, for example, a value indicating the humidification performance of each home electric appliance in each installation environment.

Next, the output amount determination unit 218 determines an output amount on the basis of a result of the comparison performed by the change value comparison unit 217 and the degree of appropriateness of the installation environment which is acquired by the size comparison unit 212 (“a” (small), “b” (appropriate), and “c” (large)). In addition, the output amount determination unit 218 stores information indicating that the output amount that starts the normal operation has been determined once (for example, a flag or an output amount numerical value) in the memory unit 202. Note that the information is information for the output amount determination unit 218 to distinguish between whether to determine an output amount when a normal operation is started or whether to determine again an output amount when a normal operation is continued (described later in detail).

For example, the server 100 stores reference values in the memory unit 202. Note that the server 100 may store reference values for each home electric appliance when operated in a predetermined installation environment (a size, a structure, a temperature, a humidity, and the like) in the memory unit 202, and may calculate reference values for other installation environments using a predetermined formula on the basis of the reference values.

In addition, for example, in a case where a result of the comparison between the acquired change value of the humidity in the installation environment and a reference value indicates that the change value of the humidity is a small value failing outside a predetermined range from the reference value, the output amount determination unit 218 evaluates that humidification performed by the air-conditioning unit 105 is insufficient, and acquires humidification performance “A”.

Similarly, in a case where the change value falls within the predetermined range of the reference value, the output amount determination unit 218 evaluates that humidification is appropriate and acquires humidification performance “B”. In a case where the change value is a large value falling outside the predetermined range from the reference value, the output amount determination unit 218 evaluates that humidification performed by the air-conditioning unit 105 is sufficient and acquires humidification performance “C”.

In addition, the output amount determination unit 218 acquires a humidification amount corresponding to the evaluated humidification performance and the degree of appropriateness acquired by the size comparison unit 212 from information indicating a relationship between humidification performance, the degree of appropriateness, and a humidification amount corresponding to the home electric appliance information of the air-conditioning unit 105.

Here, the output amount determination unit 218 may acquire the humidification performance on the basis of a result of the comparison between a total humidification amount output from the air-conditioning unit 105 in a predetermined period and a change value of the amount of water vapor contained in the installation environment in the predetermined period,

Specifically, the change value acquisition unit 216 acquires the change value of the amount of water vapor in the installation environment in a verification operation period from the air-conditioning unit 105, the change value being measured by the air-conditioning unit 105. In addition, the output amount determination unit 218 may calculate a total humidification amount in a verification operation period on the basis of the determined verification amount (humidification amount) during the verification operation, may evaluate that humidification performed by the air-conditioning unit 105 is insufficient when the change value of the amount of water vapor is a small value falling outside a predetermined range from the total humidification amount, and may acquire humidification performance “A”.

Similarly, in a case where the change value of the amount of water vapor is a value falling within a predetermined range from the total humidification amount, the output amount determination unit 218 may evaluate that humidification is appropriate and acquire humidification performance “B”. In a case where the change value of the amount of water vapor is a large value falling outside the predetermined range from the total humidification amount, the output amount determination unit 218 may evaluate that humidification is sufficient and acquire humidification performance “C”.

For example, processing in which the server 100 determines an output amount (humidification amount) when performing a normal operation after performing a verification operation with a degree of appropriateness “a” (wide) of an installation environment having a model name “K3” and a humidification amount “900” for the degree of appropriateness is as follows.

As described above, in a case where the output amount determination unit 218 evaluates that humidification is appropriate, humidification performance “B” is acquired. In addition, as illustrated in FIG. 8C, the output amount determination unit 218 determines a humidification amount “800” corresponding to the degree of appropriateness “a” and humidification performance “B”.

In addition, the server 100 causes the air-conditioning unit 105 to start a verification operation with a humidification amount “900”, increases a room humidity (see the graph Ka in FIG. 7A) and then causes the air-conditioning unit 105 to start a normal operation with a humidification amount “800”, which is smaller than the humidification amount during the verification operation, and makes the rate of increase in. humidity after starting the normal operation lower than the rate of increase in humidity during the verification operation.

In addition, processing in which the server 100 determines an output amount (humidification amount) when performing a normal operation after performing a verification operation with a humidification amount “500” for the degree of appropriateness “b” (appropriate) of an installation environment having a model name “K2” is as follows.

As described above, in a case where the output amount determination unit 218 evaluates that humidification is insufficient, the output amount determination unit 218 acquires humidification performance “A”. In addition, as illustrated in FIG. 8B, the output amount determination unit 218 acquires a humidification amount “600” corresponding to the degree of appropriateness “b” and humidification performance “A”.

In addition, the server 100 causes the air-conditioning unit 105 to start a verification operation with a humidification amount “500”, increases a room humidity (see the graph Kb in FIG. 7A) and then causes the air-conditioning unit 105 to start a normal operation with a humidification amount “600”, which is larger than the humidification amount during the verification operation, and makes the rate of increase in humidity after starting the normal operation higher than the rate of increase in humidity during the verification operation.

In this manner, the server 100 determines an appropriate humidification amount in accordance with a change value of a room humidity in a period from the start of a verification operation until after a predetermined period of time has elapsed, and causes the air-conditioning unit 105 to start a normal operation in the humidification amount. Thus, the server 100 can cause the air-conditioning unit 105 to efficiently perform a normal operation, for example, so that the room humidity does not exceed a target humidity, and can reduce power consumption.

### Processing for Server 100 to Re-Determine Output Amount

As described above, in a case where an output amount when the air-conditioning unit 105 starts a normal operation is determined once, the output amount determination unit 218 stores information indicating that the output amount has been determined once in the memory unit 202.

In addition, in a case where the information indicating that the output amount has been determined once is stored in the memory unit 202, the output amount determination unit 218 performs evaluation based on a result of comparison between a change value of a humidity and a reference value by the change value comparison unit 217. In a case where humidification performance “A” (insufficient humidification) is obtained, the output amount determination unit 218 determines again a humidification amount smaller than a predetermined humidification amount when the normal operation is started.

In other words, the server 100 causes the air-conditioning unit 105 to start a normal operation with a maximum humidification amount. In a case where there is little change in room humidity after a predetermined period of time has elapsed from the start of the normal operation, the server 100 determines that a room humidity cannot be increased to a target humidity even when a normal operation is performed with a maximum humidification amount that can be obtained by the air-conditioning unit 105, and causes the air-conditioning unit 105 to continue a humidification operation at a low humidification amount.

As described above, the server 100 causes the air-conditioning unit 105 having a model name “K1” to start a verification operation with a maximum humidification amount “400” for the degree of appropriateness “a” (wide) of the installation environment. In addition, the server 100 causes the air-conditioning unit 105 to start a normal operation with a maximum humidification amount “400” corresponding to humidification performance “A” and the degree of appropriateness “a”, on the basis of a result of the comparison between a change value of a room humidity after a predetermined period of time has elapsed from the start of the verification operation and a reference value. At this time, processing in a case where the server 100 determines an output amount (humidification amount) again is as follows.

The change value acquisition unit 216 acquires a change value of a room humidity in a period from the start of a normal operation until after a predetermined period of time has elapsed (for example, 1 hour after). Next, in a case where the comparison result obtained by the change value comparison unit 217 indicates that the change value of the humidity is a small value falling outside a predetermined range from the reference value, the output amount determination unit 218 evaluates that humidification performed by the air-conditioning unit 105 is insufficient and acquires humidification performance “A”.

Further, in a case where information indicating that an output amount for a normal. operation has been determined once is stored in the memory unit 202 and humidification performance “A” (insufficient humidification) is acquired, the output amount determination unit 218 determines again a humidification amount (for example, 180) smaller than the humidification amount “400” when the normal operation is started.

In addition, the third start information generation unit 220 generates third start information in which the humidification amount “180”, which is smaller than the humidification amount “400” when the normal operation is started, and a humidification operation are associated with each other, and the normal operation notification unit 221 transmits the third start information for performing a humidification operation with a humidification amount “180” to the air-conditioning unit 105. Thereby, the server 100 causes the air-conditioning unit 105 to continue a humidification operation with a humidification amount “180”.

The server 100 causes the air-conditioning unit 105 to start a verification operation with a maximum humidification amount “400” (see the graph Kc in FIG. 7A), causes the air-conditioning unit 105 to start a normal operation with a maximum humidification amount “400”, which is the same as the humidification amount during the verification operation, and continues a normal operation with a small humidification amount “180”, which is determined again after a predetermined period of time has elapsed from the start of the normal operation, and thus the rate of increase in humidity during the normal operation after the re-determination of the humidification amount is made lower than the rate of increase in humidity during the normal operation from the start of the verification operation.

In this manner, in a case where there is little change in room humidity in a period. from the start of the normal operation until after a predetermined period of time has elapsed even when the server 100 causes the air-conditioning unit 105 to perform the normal operation with a maximum humidification amount, the server 100 causes the air-conditioning unit 105 to continue the normal operation by changing the humidification amount to a small humidification amount. Thereby, for example, the server 100 can reduce the amount of feeding water and reduce power consumption without wasteful operation in an installation environment that exceeds the performance of the air-conditioning unit 105.

The graph Kg in FIG. 7C is a graph illustrating changes in humidity in an installation environment when the air-conditioning unit 105 performs a normal operation by re-determining a humidification amount smaller than humidification amounts at the time of the start of a verification operation and at the time of the start of a normal operation. When an output amount is determined again, the server 100 determines again a humidification amount (for example, 180) which is smaller than a predetermined humidification amount (for example, 600) when an operation is started by a conventional air-conditioning unit, and causes the air-conditioning unit 105 to start a normal operation. FIG. 7C shows that the graph Kg does not exceed a target humidity as in the graph Kh showing changes in humidity due to an operation of a conventional air-conditioning unit and has a smaller number of times of operation stopping than in the graph Kh.

That is, the server 100 determines again an appropriate humidification amount smaller than the humidification amount at the time of the start of the normal operation and performs the normal operation, and thus it is possible to reduce the frequency of repeated humidification operations and operation stopping of the air-conditioning unit 105 and reduce power consumption as compared to when the operation is continued with the same humidification amount as when the normal operation is started.

In addition, the server 100 may perform output re-determination processing a plurality of times at predetermined time intervals. Thereby, the server 100 can determine again an appropriate humidification amount in accordance with changes in the installation environment at predetermined time intervals and cause the air-conditioning unit 105 to perform a normal operation. That is, the server 100 can evaluate humidification performance for the current installation environment again on the basis of changes in outside weather or the room humidity affected by changes in the number of persons existing in the installation environment, and can determine a more appropriate humidification amount again, and thus it is possible to more efficiently operate the air-conditioning unit 105.

Here, the output amount determination unit 218 may determine any humidification amount as long as the humidification amount is smaller than a humidification amount “400”. For example, the output amount determination unit 218 may determine a more appropriate humidification amount in accordance with the remaining amount of water in a water supply tank of the air-conditioning unit 105.

Here, the third start information generation unit 220 may generate, for example, third start information including, for example, “humidification stopping” for not causing the air-conditioning unit 105 to perform a humidification operation, and the normal operation notification unit 221 may transmit the third start information to the air-conditioning unit 105 and cause the air-conditioning unit 105 to stop the humidification operation. In addition, the third start information generation unit 220 may generate, for example, third start information including operations other than a humidification operation (for example, an air cleaning operation) performed by the air-conditioning unit 105, and may cause the air-conditioning unit 105 to perform only an air cleaning operation without performing a humidification operation.

In addition, similar to a case where an output amount of a normal operation is determined, the output amount determination unit 218 may acquire humidification performance on the basis of a result of the comparison between a change value of the amount of water vapor in an installation environment in a period from the normal operation start to the predetermined time lapse and a total humidification amount in the period.

### Start Information Transmitted by Server 100

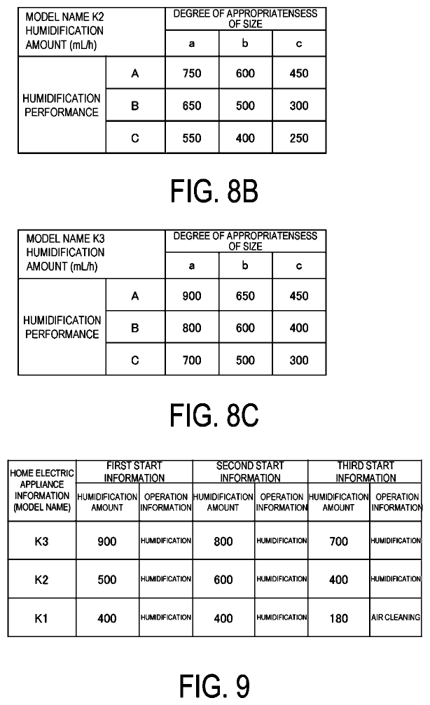

FIG. 9 is an example of first start information, second start information, and third start information that are transmitted to the air-conditioning unit 105 by the server 100.

FIG. 9 illustrates an example of each start information transmitted to the air-conditioning unit 105 in a case where changes in humidity illustrated in the graphs Ka to Kc in FIG. 7A are shown. As illustrated in FIG. 9, a graph showing changes in humidity in the installation environment of the air-conditioning unit 105 in a case where the server 100 operates the air-conditioning unit 105 with pieces of start information corresponding to a model name “K3” is the graph Ka in FIG. 7A. A graph showing changes in humidity in the installation environment in a case where the server 100 operates the air-conditioning unit 105 with pieces of start information corresponding to a model name “K2” is the graph Kb in FIG. 7A. A graph showing changes in humidity in the installation environment in a case where the server 100 operates the air-conditioning unit 105 with pieces of start information corresponding to a model name “K1” is the graph Kc in FIG. 7A.

### Processing for Server 100 to Transmit Condition Information

The verification operation notification unit 215 may transmit, for example, the first start information and the condition information to the air-conditioning unit 105. In a case where the air-conditioning unit 105 has received the condition information via the communication unit 301, the air-conditioning unit 105 outputs the condition information from the output unit 304.

Thereby, the server 100 can notify a user of the state of the installation environment which is required in a verification operation using sound or the like, and can prompt the user to adjust the state of the installation environment. In addition, the state of the installation environment is adjusted by the user, and thus the air-conditioning unit 105 can acquire a change value indicating a change in the installation environment after the verification operation as a more accurate change value. Further, the server 100 can acquire a more accurate change value, and thus an output amount at the time of starting a normal operation after the verification operation can be determined with a more appropriate value.

Note that the verification operation notification unit 215 may transmit, for example, the condition information to the smartphone 110a (or the notebook PC 110b), and the smartphone 110a may output the condition information using sound or the like.

### Processing Executed in Information Processing System 121

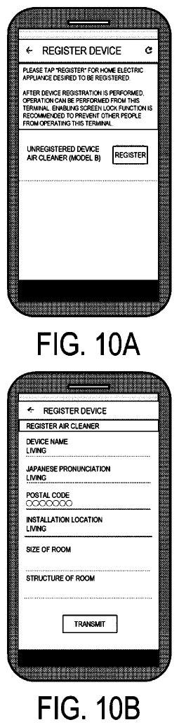

FIGS. 10A and 10B are examples of screens displayed on a user terminal (for example, the smartphone 110a). FIG. 10A is an example of a screen when the air-conditioning unit 105 is recognized by the smartphone 110a. FIG. 10B is an example of a screen when installation information regarding an installation environment in which the air-conditioning unit 105 is installed is input in the smartphone 110a.

First, when the user has installed the air-conditioning unit 105, the smartphone 110a retrieves the air-conditioning unit 105 that can be connected to the smartphone 110a on the basis of an operation performed on the smartphone 110a by the user. Next, when the smartphone 110a retrieves the air-conditioning unit 105, the smartphone 110a receives home electric appliance information (for example, a model name, a manufacturing number, and the like) from the air-conditioning unit 105 by which the air-conditioning unit 105 can be identified.

Further, in a case where the same equipment as the air-conditioning unit 105 is not registered in the server 100, the smartphone 110a displays the screen illustrated in FIG. 10A on a display unit of the smartphone 110a and prompts the user to register the air-conditioning unit 105. In a case where there is an input for registering the air-conditioning unit 105, the smartphone 110a transmits the presence of an input for registration to the air-conditioning unit 105, and the air-conditioning unit 105 transmits home electric appliance information (for example, a model name, a manufacturing number, and the like) by which the air-conditioning unit 105 can be identified and a registration request to the server 100. Here, the registration request and the home electric appliance information may be transmitted to the server 100 by the smartphone 110a.

Next, as illustrated in FIG. 10B, the smartphone 110a displays a screen for inputting installation information regarding an installation environment of an unregistered air-conditioning unit 105 on the display unit. In addition, the smartphone 110a transmits a size input to an input field of “size of room” and a structure input to an input field of “structure of room” in the screen illustrated in FIG. 10B to the server 100.

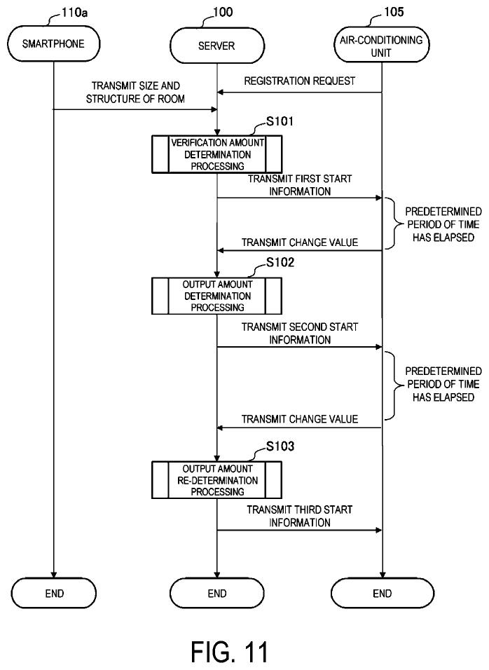

FIG. 11 is a timing chart illustrating an example of processing executed in the information processing system 121. The server 100 executes processing for determining a verification amount (verification amount determination processing) on the basis of a registration request received from the air-conditioning unit 105 and installation information regarding an installation environment which is received from the smartphone 110a (for example, the size and structure of a room) (S101). Note that the verification amount determination processing will be described later in detail.

Next, the server 100 transmits first start information including the verification amount determined in the verification amount determination processing (S101) and operation information (for example, a humidification operation) to the air-conditioning unit 105, and causes the air-conditioning unit 105 to perform the verification operation with the verification amount. In addition, the air-conditioning unit 105 transmits to the server 100 after the elapse of a predetermined period of time, a change value of a room humidity in a period from the start of the verification operation until after a predetermined period of time has elapsed.

Here, when the server 100 has transmitted a request signal for transmitting a change value of a room humidity to the air-conditioning unit 105, and the air-conditioning unit 105 has received the request signal, the air-conditioning unit 105 may transmit the change value to the server 100.

In addition, the server 100 executes processing for determining an output amount (for example, a humidification amount) (output amount determination processing) on the basis of the change value received from the air-conditioning unit 105 (S102). Note that the output amount determination processing will be described later in detail.

Next, the server 100 transmits second start information to the air-conditioning unit 105, and causes the air-conditioning unit 105 to perform a normal operation with the output amount. In addition, the air-conditioning unit 105 transmits to the server 100 after the elapse of a predetermined period of time, a change value of a room humidity in a period from the start of the normal operation until after a predetermined period of time has elapsed. Here, similarly to the case of the verification operation, the air-conditioning unit 105 may transmit the change value to the server 100 when a request signal for requesting the transmission of the change value of the room humidity has been received from the server 100.

In addition, the server 100 executes processing for determining an output amount (for example, a humidification amount) again (output amount re-determination processing) on the basis of the change value received from the air-conditioning unit 105 (S103). Note that the output amount re-determination processing will be described later in detail. Next, the server 100 transmits third start information to the air-conditioning unit 105, and causes the air-conditioning unit 105 to continue the normal operation with the output amount.

### Verification Amount Determination Processing Executed by Server 100

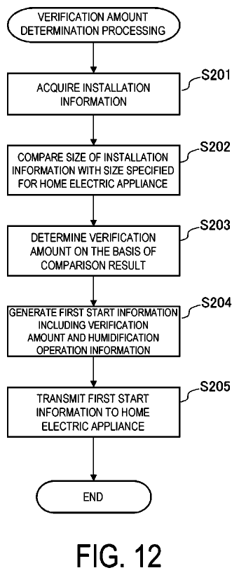

FIG. 12 is a flowchart illustrating an example of verification amount determination processing executed by the server 100. First, the installation information acquisition unit 211 acquires installation information including information regarding the installation environment of the air-conditioning unit 105 (S201). Next, the size comparison unit 212 compares the size of the installation environment included in the installation information with a size specified for each piece of home electric appliance information of the air-conditioning unit 105 (S202).

In addition, the verification amount determination unit 213 determines a verification amount on the basis of a result of the comparison between the size of the installation environment included in the installation information and the size specified for each piece of home electric appliance information of the air-conditioning unit 105 (S203). Next, the first start information generation unit 214 generates first start information for causing a home electric appliance to start a verification operation of verifying an output amount corresponding to the installation environment (S204). Finally, the verification operation notification unit 215 transmits the first start information to the air-conditioning unit 105 (S205) and terminates the processing.

### Output Amount Determination Processing Executed by Server 100

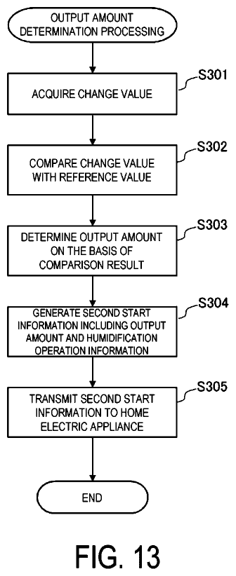

FIG. 13 is a flowchart illustrating an example of output amount determination processing of the server 100. First, the change value acquisition unit 216 receives and acquires a change value of a humidity of the installation environment in a period from the start of the verification operation until after a predetermined period of time has elapsed from the air-conditioning unit 105 (S301). Next, the change value comparison unit 217 compares the acquired change value of the humidity with a reference value specified for each piece of home electric appliance information of the air-conditioning unit 105 (S302).

In addition, the output amount determination unit 218 determines an output amount on the basis of a result of the comparison between the acquired change value of the room humidity and the reference value specified for each piece of home electric appliance information of the air-conditioning unit 105 (S303). Next, the second start information generation unit 219 generates second start information including at least the determined output amount and operation information for operating the air-conditioning unit 105 (S304). Finally, the normal operation notification unit 221 transmits the second start information to the air-conditioning unit 105 (S305) and terminates the processing.

### Output Amount Re-Determination Processing Executed by Server 100

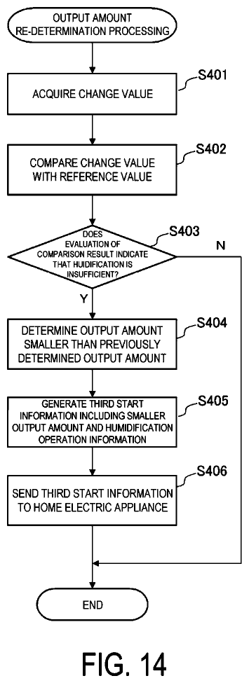

FIG. 14 is a flowchart illustrating an example of output amount re-determination processing executed by the server 100. First, the change value acquisition unit 216 receives and acquires a change value of a humidity of an installation environment in a period from the start of the normal operation until after a predetermined period of time has elapsed from the air-conditioning unit 105 (S401). Next, the change value comparison unit 217 compares the acquired change value of the humidity with a reference value specified for each piece of home electric appliance information of the air-conditioning unit 105 (S402).

In addition, the output amount determination unit 218 performs evaluation based on the result of the comparison between the change value of the humidity and the reference value and determines whether the evaluation indicates that humidification is insufficient (S403). In a case where the evaluation indicates that humidification is insufficient (Yes in S403), the output amount determination unit 218 determines again an output amount smaller than the output amount at the time of the start of the normal operation (S404),

Next, the third start information generation unit 220 generates third start information including at least an output amount smaller than the output amount at the time of the start of the normal operation and operation information for operating the air-conditioning unit 105 (S405). Finally, the normal operation notification unit 221 transmits the third start information to the air-conditioning unit 105 (S406) and terminates the processing.

Here, the server 100 may cause the air-conditioning unit 105 to perform a verification operation when the server 100 has acquired updated installation information (installation information of a new installation environment) after the air-conditioning unit 105 purchased by a user is first installed. Further, when the server 100 has acquired updated installation information (installation information of another installation environment) after the installation environment of the air-conditioning unit 105 having already been installed by the user is changed to the other installation environment, the server 100 may cause the air-conditioning unit 105 to perform the verification operation.

That is, when the user has newly installed the air-conditioning unit 105 or has changed an installation location, the server 100 can start the verification operation with an appropriate humidification amount corresponding to the updated installation information.

In addition, the server 100 may not perform the verification operation in a case where the updated installation information has not been received. Thereby, the server 100 can cause the air-conditioning unit 105 to perform only the normal operation without causing the air-conditioning unit 105 to perform the verification operation as long as the installation information of the air-conditioning unit 105 that has already had the verification operation performed is not changed, and can efficiently operate the air-conditioning unit 105.

In addition, the server 100 may start a verification operation corresponding to the installation information of the air-conditioning unit 105 on the basis of first pairing between the air-conditioning unit 105 and a user terminal (for example, the smartphone 110a) and the acquisition of the registration request from the air-conditioning unit 105. Thereby, the server 100 automatically starts the verification operation in a flow of a setting operation for the user to first register the air-conditioning unit 105 in the server 100 and sets an appropriate humidification amount at the time of the start of the normal. operation, and thus the user can efficiently perform various settings for the air-conditioning unit 105.

### Effects Achieved by Server 100

The server 100 can start a verification operation, for example, with an appropriate humidification amount corresponding to an installation environment and the performance of the air-conditioning unit 105. That is, the server 100 has an effect that an optimum output amount can be attempted until a room humidity reaches a target humidity.

In addition, as described above, the server 100 may further transmit second start information for causing the air-conditioning unit 105 to start a normal operation with an output amount determined on the basis of a change value indicating changes in an installation environment due to a verification operation to the air-conditioning unit 105.

Thereby, the server 100 can perform a normal operation with an optimum humidification amount in accordance with changes in a room humidity and the like after performing the verification operation. Thus, the server 100 has an effect that, for example, it is possible to reduce a time until the room humidity reaches a target humidity, reduce the frequency of feeding water, and reduce power consumption.

In addition, the server 100 can perform a normal operation with an optimum humidification amount on the basis of verification results in consideration of the influence of factors other than the size of the installation environment (for example, the influence of external air temperature, the influence of external humidity, the height of the ceiling, and the like) by performing the verification operation.

### Second Embodiment

For example, the server 100 may store user information acquired by the user information acquisition unit 223 in the memory unit 202, may determine a verification amount of a verification operation and an output amount of a normal operation on the basis of preferences for each user information, and may cause the air-conditioning unit 105 to perform an operation with the verification amount and the output amount.

Specifically, the server 100 stores user information (for example, a user name), installation information acquired by the installation information acquisition unit 211 (for example, a size and a structure), and home electric appliance information including information by which the air-conditioning unit 105 can be identified (for example, a model name, a serial number, a manufacturing number, and the like) in the memory unit 202 in association with each other.

In addition, the air-conditioning unit 105 transmits operation information indicating operation details related to the humidity, temperature, and the like operated by a user to the server 100. Note that the air-conditioning unit 105 may transmit the operation information to the smartphone 110a, and the smartphone 110a may transmit the operation information to the server 100.

Next, the server 100 stores the received operation information in association with the user information stored in the memory unit 202. In addition, the verification amount determination unit 213 of the server 100 may determine a humidification amount on the basis of the operation information.

Further, specifically, in a case where the server 100 has received operation information indicating operation details for increasing the humidity from the air-conditioning unit 105 a plurality of times, the server 100 determines that the user prefers high humidity, and the verification amount determination unit 213 determines a humidification amount larger than the determined humidification amount. Thereby, the server 100 can determine a larger humidification amount that matches the user's preferences on the basis of the operation information.

In addition, the server 100 may receive an operation time indicating the time when an operation has been performed, along with the operation information from the air-conditioning unit 105, and may store the operation information and the operation time in the memory unit 202 in association with the user information. The verification amount determination unit 213 may determine a humidification amount on the basis of operation information corresponding to an operation time falling within a predetermined range (for example, within 1 hour) from the time when a verification amount is determined.

Specifically, in a case where the server 100 has received operation information indicating operation details for lowering the humidity and the time when the operation time is around 10 o'clock (for example, 10 o'clock, 10:30, or the like) on a plurality of dates, the server 100 determines that the user desires to lower the humidity around 10 o'clock. In addition, when the verification amount determination unit 213 determines a humidification amount around 10 o'clock, the verification amount determination unit 213 determines a humidification amount smaller than the determined humidification amount on the basis of the operation information (for example, operation details for lowering humidity) corresponding to the operation time within a predetermined range (for example, within 1 hour) from 10 o'clock which is the time when a humidification amount is determined.

In addition, the installation information acquisition unit 211 of the server 100 may acquire, for example, a region where the air-conditioning unit 105 is installed (for example, Osaka, Okinawa, Hokkaido, or the like) from the smartphone 110a, and the storage unit 224 may store home electric appliance information of the air-conditioning unit 105, the region, and the determined verification amount (or an output amount) in the memory unit 202 in association with each other for each piece of user information. In addition, the verification amount determination unit 213 and the output amount determination unit 218 may determine a verification amount and an output amount of an air-conditioning unit 105 of a certain user with reference to a verification amount and an output amount determined by an air-conditioning unit 105 of another user in the same region as the air-conditioning unit 105 of the certain user.

### Effects Achieved by Server 100

The server 100 determines a humidification amount during a verification operation and a humidification amount during a normal operation based on an operation of a user of the air-conditioning unit 105, and thus an effect of making it possible to set an optimum humidification amount for the user is exhibited. In addition, the server 100 can determine a more appropriate verification amount and output amount on the basis of other user information in the same region where the air-conditioning unit 105 is installed.

### Supplement

The above-described embodiment may be described in the following manner, but is not limited to the following mode.

An information processing device according to a first aspect of the present disclosure may include, for example, an acquisition unit configured to acquire installation information including information regarding an installation environment of a home electric appliance, and a transmission unit configured to transmit first start information to the home electric appliance, the first start information being information for causing the home electric appliance to start a verification operation of verifying an output amount corresponding to the installation environment, after the home electric appliance is installed, and the transmission unit may cause the home electric appliance to start the verification operation with a verification amount obtained from the installation information and home electric appliance information, on the basis of information in which a relationship between the installation environment and the verification amount indicating an output amount during the verification operation is indicated for each piece of home electric appliance information including information by which the home electric appliance is able to be identified.

In an information processing device of a second aspect of the present disclosure according to the first aspect, for example, the transmission unit may cause the home electric appliance to start a humidification operation as the verification operation using a humidification amount as the verification amount when the humidification amount is obtained using the installation information and the home electric appliance information.

In an information processing device of a third aspect of the present disclosure according to the first or second aspect, the transmission unit may cause the home electric appliance to start the verification operation using, as the verification amount, a humidification amount corresponding to a result of the comparison between a size of the installation environment included in the installation information and a size specified for each piece of home electric appliance information.

An information processing device of a fourth aspect of the present disclosure according to the first to third aspects may further include a determination unit configured to determine the output amount on the basis of a change value indicating a change in the installation environment due to the verification operation, and the transmission unit may further transmit second start information for causing the home electric appliance to start a normal operation with the determined output amount.

In an information processing device of a fifth aspect of the present disclosure according to the fourth aspect, the determination unit may determine an output amount smaller than the determined output amount in a case where a change value indicating a change in the installation environment due to the normal operation is smaller than a predetermined value, after a predetermined period of time has elapsed since the normal operation started, and the transmission unit may further transmit third start information for continuing the normal operation with the smaller output amount.

In an information processing device of a sixth aspect of the present disclosure according to the fourth or fifth aspect, the determination unit may determine a humidification amount as the output amount on the basis of a change value of a humidity in the installation environment after the home electric appliance performs a humidification operation as the verification operation or the normal operation.

An information processing device of a seventh aspect of the present disclosure according to the fourth to sixth aspects may further include a storage unit configured to store user information including information regarding a user of the home electric appliance in a memory unit in association with the home electric appliance information, and the determination unit may determine the output amount further on the basis of the user information.

In an information processing device of an eighth aspect of the present disclosure according to the fourth to seventh aspects, the determination unit may evaluate a propriety of the verification amount in accordance with the change value, and determines the output amount from the evaluation result and the installation information.

In an information processing device of a ninth aspect of the present disclosure according to the first to eighth aspects, the acquisition unit may acquire the installation information input by the user of the home electric appliance from a user terminal via a predetermined interface presented to the user terminal.

In an information processing device of a tenth aspect of the present disclosure according to the first to ninth aspects, the acquisition unit may acquire updated installation information in a case where the installation information is updated, and the transmission unit may transmit the first start information for causing the home electric appliance to start the verification operation to the home electric appliance in a case where the updated installation information is acquired.

In an information processing device of an eleventh aspect of the present disclosure according to the tenth aspect, the acquisition unit may acquire the updated installation information in a case where a registration request for registering the home electric appliance in the information processing device is acquired.

In an information processing device of a twelfth aspect of the present disclosure according to the first to eleventh aspects, the transmission unit may further transmit condition information for presenting a condition for setting the installation environment to the home electric appliance to the user of the home electric appliance.

A home electric appliance according to a thirteenth aspect of the present disclosure may include a start information reception unit configured to receive first start information for starting a verification operation of verifying an output amount corresponding to an installation environment from the information processing device according to any one of the first to twelfth aspects, and a measured value transmission unit configured to transmit a measured value obtained by the verification operation.

An information processing system according to a fourteenth aspect of the present disclosure may include the information processing device of any one of the above-described first to twelfth aspects, and the home electric appliance of the thirteenth aspect.

An information processing system of a fifteenth aspect of the present disclosure according to the fourteenth aspect may further include a user terminal configured to transmit installation information input via a predetermined interface to the information processing device.

A method of controlling an information processing device according to a sixteenth aspect of the present disclosure may include an acquisition step of acquiring installation information including information regarding an installation environment of a home electric appliance, and a transmission step of transmitting first start information to the home electric appliance, the first start information being information for causing the home electric appliance to start a verification operation of verifying an output amount corresponding to the installation environment, after the home electric appliance is installed, and in the transmission step, the home electric appliance may be caused to start the verification operation with a verification amount obtained from the installation information and home electric appliance information, on the basis of information in which a relationship between the installation environment and the verification amount indicating an output amount during the verification operation is indicated for each piece of home electric appliance information including information by which the home electric appliance is able to be identified.

A control program according to a seventeenth aspect of the present disclosure may cause an information processing device to realize an acquisition function of acquiring installation information including information regarding an installation environment of a home electric appliance, and a transmission function of transmitting first start information to the home electric appliance, the first start information being information for causing the home electric appliance to start a verification operation of verifying an output amount corresponding to the installation environment, after the home electric appliance is installed, and the transmission function may cause the home electric appliance to start the verification operation with a verification amount obtained from the installation information and home electric appliance information, on the basis of information in which a relationship between the installation environment and the verification amount indicating an output amount during the verification operation is indicated for each piece of home electric appliance information including information by which the home electric appliance is able to be identified.

### Implementation Example by Software

A control block provided in the server 100 (each of the units included in the control unit 210) may be implemented by software using a controller (a processor), such as a central processing unit (CPU). In other words, the server 100 includes a CPU that executes command of a control program, which is software for implementing each function, a read only memory (ROM) or a storage device (these are each referred to as a “recording medium”) that stores the control program and various types of data in a manner capable of being read by a computer (or the CPU), a random access memory (RAM) that develops the control program, and the like. In addition, the computer (or the CPU) reads the control program from the recording medium and executes the control program to achieve an example of the object of an aspect of the present disclosure. As the recording medium, a “non-transitory tangible medium”, such as a tape, a disk, a card, a semiconductor memory, and a programmable logic circuit may be used. Further, the control program may be supplied to the computer via a chosen transmission medium (a communication network, a broadcast wave, or the like) capable of transmitting the control program. Note that an aspect of the present disclosure may be implemented in the form of a data signal embedded in a carrier wave, in which the above-described control program is realized by electronic transmission. Note that the control program can be implemented in any programming language. For example, the control program may be implemented using a scripting language such as ActionScript or JavaScript (trademarks), an object-oriented programming language such as Objective-C and Java (trademarks), a markup language such as HTML5, and the like. Further, a server that is provided with an information processing terminal (a smartphone or a personal computer, for example) provided with each of units that implement each function implemented by the control program, and with each of units that implement remaining functions other than each of the functions described above is also included within the scope of the present disclosure.

1. An information processing device comprising:
an acquisition unit configured to acquire installation information including information regarding an installation environment of a home electric appliance; and
a transmission unit configured to transmit first start information to the home electric appliance, the first start information being information for causing the home electric appliance to start a verification operation of verifying an output amount corresponding to the installation environment, after the home electric appliance is installed,
wherein the transmission unit causes the home electric appliance to start the verification operation with a verification amount obtained from the installation information and home electric appliance information, on the basis of information in which a relationship between the installation environment and the verification amount indicating an output amount during the verification operation is indicated for each piece of home electric appliance information including information by which the home electric appliance is able to be identified.

2. The information processing device according to claim 1,
wherein the transmission unit causes the home electric appliance to start a humidification operation as the verification operation using a humidification amount as the verification amount when the humidification amount is obtained using the installation information and the home electric appliance information.

3. The information processing device according to claim 1,
wherein the transmission unit causes the home electric appliance to start the verification operation using, as the verification amount, a humidification amount corresponding to a result of the comparison between a size of the installation environment included in the installation information and a size specified for each piece of home electric appliance information.

4. The information processing device according to claim 1, further comprising:
a determination unit configured to determine the output amount on the basis of a change value indicating a change in the installation environment due to the verification operation,
wherein the transmission unit further transmits second start information for causing the home electric appliance to start a normal operation with the determined output amount.

5. The information processing device according to claim 4,
wherein the determination unit determines an output amount smaller than the determined output amount in a case where a change value indicating a change in the installation environment due to the normal operation is smaller than a predetermined value after a predetermined period of time has elapsed since the normal operation started, and
the transmission unit further transmits third start information for continuing the normal operation with the smaller output amount.

6. The information processing device according to claim 4,
wherein the determination unit determines a humidification amount as the output amount on the basis of a change value of a humidity in the installation environment after the home electric appliance performs a humidification operation as the verification operation or the normal operation.

7. The information processing device according to claim 4, further comprising:
a storage unit configured to store user information including information regarding a user of the home electric appliance in a memory unit in association with the home electric appliance information,
wherein the determination unit determines the output amount further on the basis of the user information.

8. The information processing device according to claim 4,
wherein the determination unit evaluates a propriety of the verification amount in accordance with the change value, and determines the output amount from the evaluation result and the installation information.

9. The information processing device according to claim 1,
wherein the acquisition unit acquires the installation information input by the user of the home electric appliance from a user terminal via a predetermined interface presented to the user terminal.

10. The information processing device according to claim 1,
wherein the acquisition unit acquires updated installation information in a case where the installation information is updated, and
the transmission unit transmits the first start information for causing the home electric appliance to start the verification operation to the home electric appliance in a case where the updated installation information is acquired.

11. The information processing device according to claim 10,
wherein the acquisition unit acquires the updated installation information in a case where a registration request for registering the home electric appliance in the information processing device is acquired.

12. The information processing device according to claim 1,
wherein the transmission unit further transmits condition information for presenting a condition for setting the installation environment to the home electric appliance to the user of the home electric appliance.

13. A home electric appliance comprising:
a start information reception unit configured to receive first start information for starting a verification operation of verifying an output amount corresponding to an installation environment from the information processing device according to claim 1; and
a measured value transmission unit configured to transmit a measured value obtained by the verification operation.

14. An information processing system comprising:
the information processing device according to claim 1; and
a home electric appliance,
wherein the home electric appliance comprising:
a start information reception unit configured to receive first start information for starting a verification operation of verifying an output amount corresponding to an installation environment from the information processing device; and
a measured value transmission unit configured to transmit a measured value obtained by the verification operation.

15. The information processing system according to claim 14, further comprising:
a user terminal configured to transmit installation information input via a predetermined interface to the information processing device.

16. A method of controlling an information processing device, the method comprising:
an acquisition step of acquiring installation information including information regarding an installation environment of a home electric appliance; and
a transmission step of transmitting first start information to the home electric appliance, the first start information being information for causing the home electric appliance to start a verification operation of verifying an output amount corresponding to the installation environment, after the home electric appliance is installed,
wherein in the transmission step, the home electric appliance is caused to start the verification operation with a verification amount obtained from the installation information and home electric appliance information, on the basis of information in which a relationship between the installation environment and the verification amount indicating an output amount during the verification operation is indicated for each piece of home electric appliance information including information by which the home electric appliance is able to be identified.

17. (canceled)
